(19) United States
(12) Patent Application Publication
(10) Pub. No.: US 2011/0153637 A1
(43) Pub. Date: Jun. 23, 2011

(54) INTEGRATED FIREARM INFORMATION SYSTEM

(76) Inventors: Jorge R. Bailey, Vancouver, WA (US); James D. Berreth, Vancouver, WA (US)

(21) Appl. No.: 12/640,672

(22) Filed: Dec. 17, 2009

(51) Int. Cl. G06F 17/30

(52) U.S. Cl. 707/769; 707/802; 707/E17.044; 707/E17.014

(57) ABSTRACT

System and method for collecting, storing, and providing information related to firearms. More specifically, an embodiment tracks ownership and/or possession of a firearm from its manufacture onward (i.e., from cradle to grave) between and among registered firearm manufactures, firearm sellers/dealers, individual gun owners, pawn shops, law enforcement agencies, government agencies, and any other entity or individual stakeholder that may own and/or posses the firearm. An embodiment may further authenticate firearm-related transactions, provide notifications to registered users, and enable local and global reports of loss, theft, and/or the use in a crime.

### FIELD OF THE INVENTION

The present invention relates to a system and method of a system to store and monitor information related to firearms and other weapons.

### BACKGROUND

A number of devices or services have compiled data related to firearms and firearm ballistic data. The following represents a list of known related art:

| | | Date of |
|---|---|---|
| Reference: | Issued to: | Issue/Publication: |
| US Pat. App. Pub 2009/0028379 | Belanger et al. | Jan. 29, 2009 |
| US Pat. App. Pub 2009/0037374 | Delia et al. | Feb. 5, 2009 |
| US Pat. App. Pub 2007/0118562 | Edwards | May 24, 2007 |
| US Pat. App. Pub 2006/0177104 | Prokoski | Aug. 10, 2006 |
| US Pat. App. Pub 2006/0174531 | Lizotte et al. | Aug. 10, 2006 |
| US Pat. App. Pub 2005/0262751 | Leslie | Dec. 1, 2005 |
| US Pat. App. Pub 2002/0032626 | DeWolf et al. | Mar. 14, 2002 |
| U.S. Pat. No. 7,380,706 | Lightfoot et al. | Jun. 3, 2008 |
| U.S. Pat. No. 6,779,716 | Grow | Aug. 24, 2004 |
| U.S. Pat. No. 3,778,781 | Roth | Dec. 11, 1973 |

The teachings of each of the above-listed citations (which does not itself incorporate essential material by reference) are herein incorporated by reference. None of the above inventions and patents, taken either singularly or in combination, is seen to describe the instant invention as claimed.

For example, U.S. Pat. No. 3,778,781 to Roth describes an installation for registering the serial numbers of firearms in a computer, a plurality of stations, each having a television receiver displaying the image of the serial number of a firearm being registered, and a unit operatively associated with the computer and providing a keyboard and a display screen next to the television receiver, with an operator assigned to each station, and each operator instructed first to produce, by selective manipulation of keys of the keyboard, a duplicate of the televised serial number for appearance of an image of the operator-produced number on the display screen, then visually to compare the number images for their identity or non-identity, and finally to cause entry in the computer of the operator-produced serial number if found by the operator to be identical with the televised serial number. The computer is programmed for various processing of the entered serial numbers, including a test of the latter for their identity or non-identity, and their clearance for further processing toward registration and storage if found identical, but cancellation of the entered serial numbers if found non-identical and signaling of the non-identity of the entered serial numbers to the operators.

U.S. Pat. No. 6,779,716 to Grow describes a computer-controlled laser etching probe to etch a firearm-identifying indicia such as a barcode encoded serial number into the barrel and breech of a bore of a firearm. Owner registration data coupled with the serial number is stored in a central database. A computer-controlled scanner reads the barcode from a slug or casing or a bullet fired from an etched firearm for comparison with registration data in the central database, thereby identifying the registered owner of the firearm from which the bullet was fired. Crime scene data including GPS data identifying the location of the crime, barcoded slugs or casings, registration data associated with the identified firearm, and the last known residence of the registered owner along with derived data may be used to determine a probability map of the location of a criminal suspect.

U.S. Pat. No. 7,380,706 to Lightfoot et al. describes firearm identification kit including a data storage media bearing ballistics information and other indicia that may be useful in matching a fired spent cartridge case or bullet to the firearm that fired it.

US Pat. App. Pub 2002/0032626 to DeWolf et al. describes recording information related to an asset in an asset registry throughout the life cycle of the asset. Categorizing the information into multiple attributes. Managing read and write privileges to the asset registry for various entities having an interest in the asset. Providing access to the attributes to the various entities that have an interest in the asset. Entities having write privileges can write information to the asset registry, and entities having read privileges can read information from the asst registry.

US Pat. App. Pub 2005/0262751 to Leslie describes a system for detecting the presence of firearms and identifying their unique status includes a radiofrequency identification chip supported within each firearm either by the manufacturer or by later retrofit. The RFID chip stores the unique serial number for the firearm, preferably in nonvolatile form. A reader for the chips may be used to transmit an interrogating signal from a distance which causes the chip to send a responsive signal including its serial number. The reader picks up the serial number and provides it to an associated computer. The serial number so obtained may be used with databases to maintain inventories of firearms or determine the history of firearms.

US Pat. App. Pub 2006/0174531 to Lizotte et al. describes an indicia for marking on an object, such as a cartridge case, for representing selected information, such as identification indicia identifying the firearm that discharged the cartridge, and methods and apparatus for generating, imprinting and reading the identification indicia. An indicia includes a multi-dimensional array of encoded marks, including encoded marks determined by spectral encoding variables representing the selected information wherein each spectral variable is spectrally distinguishable from others of the spectral variables representing variables, and an encoded pattern of the encoded marks is determined by algorithmic transformation of the selected information. An indicia may also include hologram related artwork. An indicia may be an encoded hologram multi-dimensional barcode, an encoded hologram or an encoded concentric circular barcode and may be formed of a single indicia or as an array of indicia.

US Pat. App. Pub 2006/0177104 to Prokoski describes a systematic use of infrared imaging characterizes marks made on items and identifies the particular marking tool with better accuracy than use of visual imaging. Infrared imaging performed in total darkness eliminates shadows, glint, and other lighting variations and artifacts associated with visible imaging. Although normally used to obtain temperature measurements, details in IR imagery result from emissivity variations as well as thermal variations. Disturbing an item's surface texture creates an emissivity difference producing local changes in the infrared image. Identification is most accurate when IR images of unknown marks are compared to IR images of marks made by known tools. However, infrared analysis offers improvements even when only visual reference images are available. Comparing simultaneous infrared and visual images of an unknown item, such as bullet or shell casing, can detect illumination-induced artifacts in the visual image prior to searching the visual database, thereby reducing potential erroneous matches.

US Pat. App. Pub 2007/0118562 to Edwards describes methods for linking multiple events involving firearms submit event information data and firearms information data to a system that includes a database for multiple firearms events and generate a query map that correlates data in the system database with a preselected geographical grid based upon one or more preselected matching criteria to one or more data entries for a selected event. The map is used to generate a request for a possible link analysis (e.g., a NIBIN analysis) which may be initiated by a firearms examiner and is then performed to determine if there is a link. The event information data can include a case number, a geographical location data entry, a date entry, a crime type, a weapon involved and a suspect information data field based upon input from an investigating officer while the firearms information data can include a weapon data entry (such as a weapon type and caliber) and a bullet data entry (such as a lands and grooves entry, a direction of twist entry, a lands measurement and a grooves measurement) based upon input from a person with firearms examiner training. The methodology can be used to prioritize multiple requests for a possible link analysis based upon information obtained in one or more query responses and the query response can display at least some of its information in a query map that correlates data in the system database with a preselected geographical grid.

US Pat. App. Pub 2009/0037374 to Delia et al. describes a method for utilizing firearm discharge data in a crime reporting and tracking database, includes: recording one or more discharges of a firearm; transmitting information from the discharging firearm to a crime reporting and tracking database; utilizing the transmitted information to establish relationships between the discharged firearm, committed crimes, and missing persons within the crime reporting and tracking database; and wherein the recording and transmitting is carried out by devices within the firearm.

US Pat. App. Pub 2009/0028379 to Belanger et al. describes a system and method for identifying, test firing, marking, and imaging firearm cartridge cases and firearms for use by firearm manufactures. The system and method includes five subsystems, which work in the following sequence: a firearm serial number recognition sub-system; a cartridge case recovery sub-system; a cartridge case sorting sub-system; a cartridge case marking sub-system; and an image acquisition sub-system. The firearm serial number recognition sub-system reads the serial number of a firearm and stores it in a database. The cartridge case recovery sub-system recovers fired cartridge cases and transports them to the sorting sub-system. The cartridge case sorting sub-system identifies the orientation of the cartridge cases and reorients them, if necessary, for marking. The cartridge case marking sub-system stamps the firearm serial numbers on the cartridge cases. The serial number is encrypted in a 2D matrix (barcode) form on the casings. The image acquisition sub-system acquires the firing pin and breech face images of a cartridge case after reading the stamped serial number on its side.

### SUMMARY AND ADVANTAGES

The integrated firearm information database of an embodiment of the present invention presents numerous advantages, including: (1) tracks ownership information, chain of title, and/or chain of possession from the manufacture of the firearm onward through all sales, transfers, and other transactions; (2) tracks ballistic data for a firearm; (3) authenticates firearm purchasers and/or transferees; (4) provides manufacturers efficient means to distribute notices (e.g., recall notices) directly to the firearm owner and/or possessor; (5) provide the ability to broadcast a report that the firearm has been lost or stolen; (6) provides the ability to locate the owner and/or possessor of a found firearm and/or a firearm used in committing a crime; and (7) privately and securely maintains firearm and firearm-related records;

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 illustrates the network topology of the firearms information system of an embodiment;

FIG. 2 illustrates a node of the firearms information system of an embodiment;

FIG. 3 illustrates a process flow for a firearm sale between a manufacturer and a firearm dealer;

FIG. 4 illustrates a process flow for a firearm sale between a manufacturer and a firearm dealer;

FIG. 5 illustrates a process flow for a firearm sale between a firearm dealer and an individual;

FIG. 6 illustrates a process flow for a firearm sale between a firearm dealer and an individual;

FIG. 7 illustrates a process flow for a firearm sale between a pawn shop and an individual.

FIG. 8 illustrates a process flow for a firearm sale between an individual and a pawn shop.

FIG. 9 illustrates a process flow for a firearm sale between an individual and a pawn shop.

FIG. 10 illustrates a process flow for a firearm sale between two individuals.

FIG. 11 illustrates a process flow for law enforcement finding a firearm; and

FIG. 12 illustrates a process flow for law enforcement receiving a report of a stolen firearm.

### REFERENCE NUMBERS USED IN DRAWINGS

Turning now descriptively to the drawings, in which similar reference characters denote similar elements throughout the several views, the figures illustrate the net assembly of the present invention. With regard to the reference numerals used, the following numbering is used throughout the various drawing figures:

100 communication system

110 node

120 node

130 node

140 component

150 module

160 wireless shared media

162 data channel

164 data packet

170 network

210 processor

220 switch

230 transmitter

240 receiver

250 antenna

260 memory

300 integrated firearm information system

310 tracking module

320 manufacturer module

330 seller module

340 law enforcement module

350 individual module

360 government agency module

370 pawn shop module

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Simply stated, embodiments are a system and method for collecting, storing, and providing information related to firearms. More specifically, an embodiment tracks ownership and/or possession of a firearm from its manufacture onward (i.e., from cradle to grave) between and among registered firearm manufactures, firearm sellers/dealers, individual gun owners, pawn shops, law enforcement agencies, government agencies, and any other entity or individual stakeholder that may own and/or posses the firearm. An embodiment may further authenticate firearm-related transactions, provide notifications to registered users, and enable local and global reports of loss, theft, and/or the use in a crime.

As used herein, “firearm” may include any device generally operable by an individual that projects one or more projectiles at a substantially high velocity through a controlled explosion or deflagration of a propellant. Examples may include a rifle, bolt-action rifle, lever-action rifle, pump-action rifle, semi-automatic rifle, muzzle-loading rifle, black powder rifle, handgun, semi-automatic handgun, pistol, revolver, shotgun, pump-action shotgun, semi-automatic shotgun, automatic shotgun, machine gun, submachine gun, machine pistol, or any other device that utilizes a propellant to fire or project one or more projectiles. Generally speaking, firearms utilize firearm cartridges that include a cartridge case, a propellant, a primer, and a bullet. The embodiments are not limited in this context.

As used herein, a “projectile weapon” may include any device generally operable by an individual that projects one or more projectiles at a substantially high velocity. Examples may include a firearm, air-powered rifle, air-powered pistol, longbow, recurve bow, compound bow, crossbow, a coilgun, a Gauss gun, or any other kinetic energy weapon.

As further used herein, “ballistic data” may include one or more features or characteristics of a firearm cartridge that may individually or in combination substantially uniquely identify the firearm that fired the cartridge. In particular, the ballistic data may represent one or more features or characteristics of the once-fired cartridge case (i.e., “brass”), primer, and/or bullet. For example, a once-fired cartridge case may include a scar, mark, or other indentation adjacent to the cartridge case rim that is imparted by an ejector, extractor, or the like. A once-fired cartridge case may further include a burn and/or powder residue pattern on the external surface(s) of the cartridge case. Further, the breech face of the once-fired cartridge case may include a scar, mark, or other indentation imparted by a firing pin or the like to ignite the primer. The primer may be contained in the rim of the cartridge case (e.g., for a rim fire cartridge) or may be a separate component included in the cartridge case (e.g., for a center fire cartridge). A once-fired bullet may include one or more marks, indentations, striations, and the like imparted by the barrel from which bullet was fired. More specifically, the once-fired bullet may include one or more marks, indentations, or striations indicative of the lands and grooves of a rifled barrel or any other barrel (e.g., polygonal) that imparts twist or spin on the fired bullet. The ballistic data may be generated and/or collected by any collection method or system known in the art.

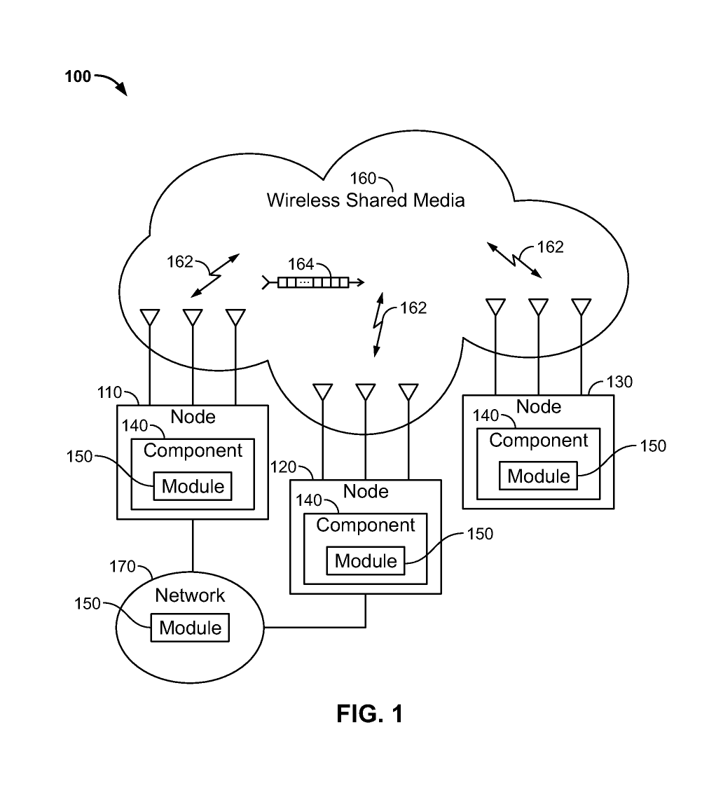

FIG. 1 illustrates a block diagram of a communications system 100. In an embodiment, communications system 100 may comprise an integrated firearm information system 300. In various embodiments, the communications system 100 may comprise multiple nodes. A node generally may comprise any physical or logical entity for communicating information in the communications system 100 (e.g., firearm information in the integrated firearm information system 300) and may be implemented as hardware, software, or any combination thereof, as desired for a given set of design parameters and/or performance constraints. Although FIG. 1 may show a limited number of nodes by way of example, it can be appreciated that more or fewer nodes may be employed for a given implementation.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a set top box (STB), a telephone, a mobile telephone, a cellular telephone, a smartphone, a handset, a wireless access point, a base station (BS), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a network processor, and so forth. The embodiments are not limited in this context.

The nodes of the communications system 100 may be arranged to communicate one or more types of information, such as media information and control information. Media information generally may refer to any data representing content meant for a user, such as image information, video information, graphical information, audio information, voice information, textual information, numerical information, alphanumeric symbols, character symbols, and so forth. Control information generally may refer to any data representing commands, instructions or control words meant for an automated system. For example, control information may be used to route media information through a system, or instruct a node to process the media information in a certain manner. The media and control information may be communicated from and to a number of different devices or networks.

In various implementations, the nodes of the communications system 100 may be arranged to segment a set of media information and control information into a series of packets. A packet generally may comprise a discrete data set having fixed or varying lengths, and may be represented in terms of bits or bytes. It can be appreciated that the described embodiments are applicable to any type of communication content or format, such as packets, cells, frames, fragments, units, and so forth.

The communications system 100 may communicate information in accordance with one or more standards, such as standards promulgated by the IEEE, the Internet Engineering Task Force (IETF), the International Telecommunications Union (ITU), and so forth. In various embodiments, for example, the communications system 100 may communicate information according to one or more IEEE 802 standards including IEEE 802.11 standards (e.g., 802.11a, b, g/h, j, n, and variants) for WLANs and/or 802.16 standards (e.g., 802.16-2004, 802.16.2-2004, 802.16e, 802.16f, and variants) for WMANs. The communications system 100 may communicate information according to one or more of the Digital Video Broadcasting Terrestrial (DVB-T) broadcasting standard and the High performance radio Local Area Network (HiperLAN) standard. The embodiments are not limited in this context.

In various embodiments, the communications system 100 may employ one or more protocols such as medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), and so forth.

The communications system 100 may include one or more nodes (e.g., nodes 110-130) arranged to communicate information over one or more wired and/or wireless communications media. Examples of wired communications media may include a wire, cable, printed circuit board (PCB), backplane, switch fabric, semiconductor material, twisted-pair wire, co-axial cable, fiber optics, and so forth. An example of a wireless communication media may include portions of a wireless spectrum, such as the radio-frequency (RF) spectrum. In such implementations, the nodes of the communication system 100 may include components and interfaces suitable for communicating information signals over the designated wireless spectrum, such as one or more transmitters, receivers, transceivers, amplifiers, filters, control logic, antennas and so forth.

The communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), a line card, a disc controller, video controller, audio controller, and so forth.

In various embodiments, the communications system 100 may comprise or form part of a network, such as a WiMAX network, a broadband wireless access (BWA) network, a WLAN, a WMAN, a wireless wide area network (WWAN), a wireless personal area network (WPAN), a Code Division Multiple Access (CDMA) network, a Wide-band CDMA (WCDMA) network, a Time Division Synchronous CDMA (TD-SCDMA) network, a Time Division Multiple Access (TDMA) network, an Extended-TDMA (E-TDMA) network, a Global System for Mobile Communications (GSM) network, an Orthogonal Frequency Division Multiplexing (OFDM) network, an Orthogonal Frequency Division Multiple Access (OFDMA) network, a North American Digital Cellular (NADC) network, a Universal Mobile Telephone System (UMTS) network, a third generation (3G) network, a fourth generation (4G) network, a local area network (LAN), a wide area network (WAN), a metropolitan area network (MAN), the Internet, the World Wide Web, a cellular network, a radio network, a satellite network, and/or any other communications network configured to carry data. The embodiments are not limited in this context.

The communications system 100 may employ various modulation techniques including, for example: OFDM modulation, Quadrature Amplitude Modulation (QAM), N-state QAM (N-QAM) such as 16-QAM (four bits per symbol), 32-QAM (five bits per symbol), 64-QAM (six bits per symbol), 128-QAM (seven bits per symbol), and 256-QAM (eight bits per symbol), Differential QAM (DQAM), Binary Phase Shift Keying (BPSK) modulation, Quadrature Phase Shift Keying (QPSK) modulation, Offset QPSK (OQPSK) modulation, Differential QPSK (DQPSK), Frequency Shift Keying (FSK) modulation, Minimum Shift Keying (MSK) modulation, Gaussian MSK (GMSK) modulation, and so forth. The embodiments are not limited in this context.

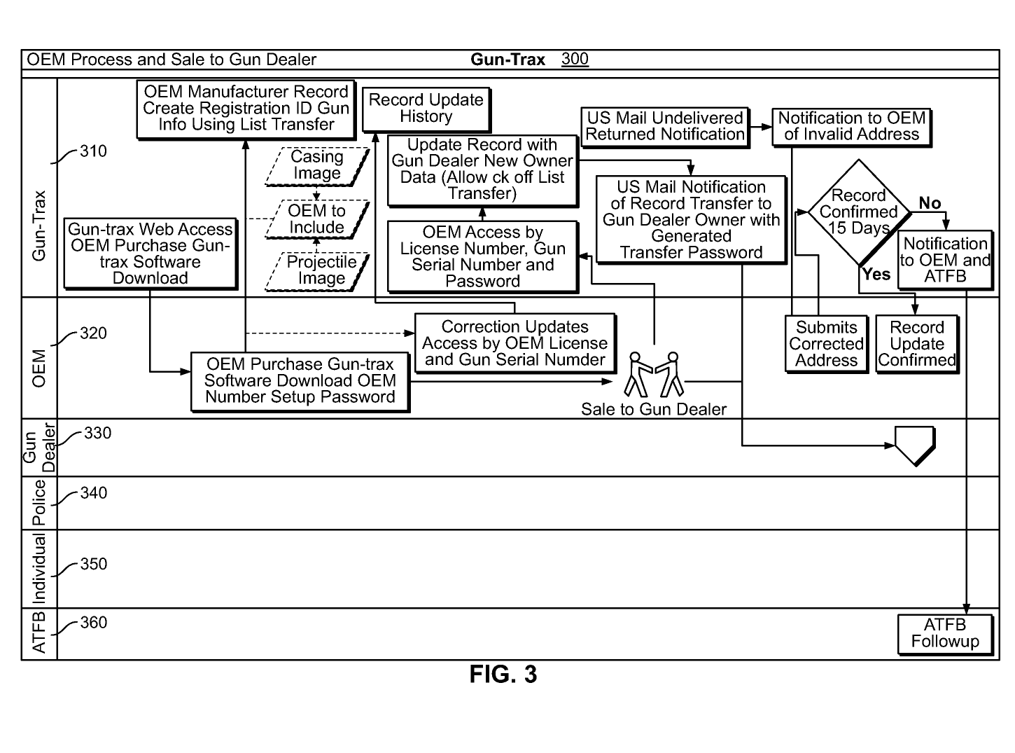

In one embodiment, communications system 100 may include one or more wireless communication devices, such as nodes 110-130. Nodes 110-130 all may be arranged to communicate information using one or more wireless transmitters/receivers (“transceivers”) or radios, which may involve the use of radio frequency communication via 802.11 schemes (e.g., 802.11a, b, g/h, j, n, and variants), 802.16 schemes (e.g., 802.16-2004, 802.16.2-2004, 802.16e, 802.16f, and variants), and/or a cellular or mobile phone scheme, for example. Nodes 110-130 may communicate using the radios over wireless shared media 160 via multiple inks or channels established therein. Although FIG. 1 is shown with a limited number of nodes in a certain topology, it may be appreciated that communications system 100 may include additional or fewer nodes in any type of topology as desired for a given implementation. For example, nodes 110-130 may include one or more modules 150. Modules 150 may further comprise a tracking module 310, a manufacturer module 320, a sales module 330, a law enforcement module 340, an owner module 350, a government agency module 360, and/or a combination or subset thereof to form the integrated firearm information system 300 of an embodiment as will be described below with reference to FIGS. 3-13. The embodiments are not limited in this context.

Further, nodes 110 and 120 may comprise fixed devices having wireless capabilities. A fixed device may comprise a generalized equipment set providing connectivity, management, and control of another device, such as mobile devices. Examples for nodes 110 and 120 may include a wireless access point (AP), base station or node B, router, switch, hub, gateway, media gateway, and so forth. In an embodiment, nodes 110 and 120 may also provide access to a network 170 via wired communications media. Network 170 may comprise, for example, a packet network such as the Internet, a corporate or enterprise network, a voice network such as the Public Switched Telephone Network (PSTN), among other WANs, for example. The embodiments are not limited in this context.

In one embodiment, system 100 may include node 130. Node 130 may comprise, for example, a mobile device or a fixed device having wireless capabilities. A mobile device may comprise a generalized equipment set providing connectivity to other wireless devices, such as other mobile devices or fixed devices. Examples for node 130 may include a computer, server, workstation, notebook computer, handheld computer, telephone, cellular telephone, personal digital assistant (PDA), combination cellular telephone and PDA, smartphone, and so forth. For example, the mobile device may be an Apple iPhone, a Palm Treo, an RIM Blackberry, or any other smartphone.

Nodes 110-130 may have one or more wireless transceivers and wireless antennas. In one embodiment, for example, nodes 110-130 may each have multiple transceivers and multiple antennas to communicate information signals over wireless shared media 160. For example, a data channel 162, link, or connection may be formed using one or more frequency bands of wireless shared medium 160 for transmitting and receiving one or more data packets 164. The embodiments are not limited in this context.

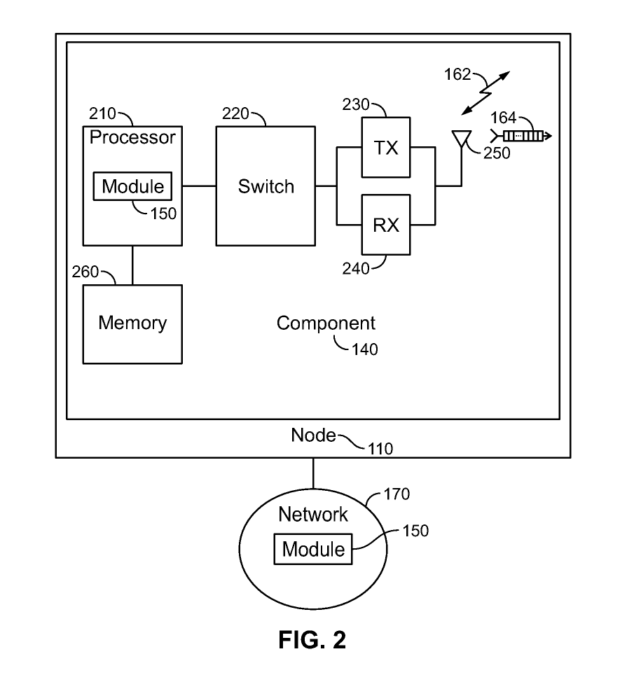

FIG. 2 more specifically illustrates node 110 of the communications system 100. As shown in FIG. 2, the node may comprise multiple elements such as component 140, module 150, processor 210, memory 260, switch 220, transmitter 230, receiver 240, and antenna 250 to communicate data packets 164 over wireless shared media 160. Transmitter 230 and receiver 240 may also be collectively referred to as a transceiver. Antenna 250 may include an internal antenna, an omni-directional antenna, a monopole antenna, a dipole antenna, an end fed antenna or a circularly polarized antenna, a micro-strip antenna, a diversity antenna, a dual antenna, an antenna array, and so forth. Some elements may be implemented using, for example, one or more circuits, components, registers, processors, software subroutines, or any combination thereof. Although FIG. 2 shows a limited number of elements, it can be appreciated that additional or fewer elements may be used in node 110 as desired for a given implementation. Further, though illustrated with respect to wireless transmission, reception, and/or communication of data packets 164, node 110 may additionally or alternately communicate data packets 164 over wired shared media (not illustrated) The embodiments are not limited in this context.

As noted, in an embodiment, node 110 may include a processor 210. Processor 210 may be connected to switch 220 and/or the transceiver (e.g., transmitter 230 and receiver 240). Processor 210 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In an embodiment, for example, processor 210 may be implemented as a general purpose processor, such as a general purpose processor made by Intel Corporation of Santa Clara, Calif. or Advanced Micro Devices, Inc. of Sunnyvale, Calif. Processor 210 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments are not limited in this context.

In one embodiment, processor 210 may include, or have access to, memory 260. Memory 260 may comprise any machine-readable media. Memory 260 may be implemented using any machine-readable or computer-readable media capable of storing data, including both volatile and non-volatile memory. For example, memory 260 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 260 may be included on the same integrated circuit as processor 210, or alternatively some portion or all of memory 260 may be disposed on an integrated circuit or other medium, for example a hard disk drive, that is external to the integrated circuit of processor 210. The embodiments are not limited in this context.

When implemented in a node of communications system 100, node 110 may be arranged to communicate information over wireless shared media 160 between and/or among the various nodes, such as nodes 120 and 130. Additionally or alternately, node 110 may be arranged to communicate between and/or among the various nodes via wired shared media (not illustrated), for example over network 170. The information may be communicated (e.g., via wired shared media, wireless shared media 160, and/or a combination thereof) in the form of packets 164 with each packet 164 comprising media information and/or control information. A packet 164 in this context may refer to any discrete set of information, including a unit, frame, cell, segment, fragment, and so forth. The packet 164 may be of any size suitable for a given implementation. The embodiments are not limited in this context.

Specifically, in an embodiment the communication system 100 may be arranged to communicate information to coordinate, operate, and/or control an integrated firearms information system 300. For example, one or more modules 150 may communicate and/or interoperate with each other to substantially form the integrated firearms information system 300. More specifically, and as introduced above, one or more modules 150 may further comprise a tracking module 310, a manufacturer module 320, a sales module 330, a law enforcement module 340, an owner module 350, a government agency module 360, and/or a combination or subset thereof depending on one or more applications of the integrated firearms information system 300. The embodiments are not limited in this context. The interoperation of the modules 310-360 and one or more processes performed thereby will be described below with reference to FIGS. 3-13 that illustrate various instances and/or applications of the collection, organization, generation, distribution, and/or a combination thereof of firearms information. Each will be described in turn.

Original Equipment Manufacturer Process and Sale to Gun Dealer

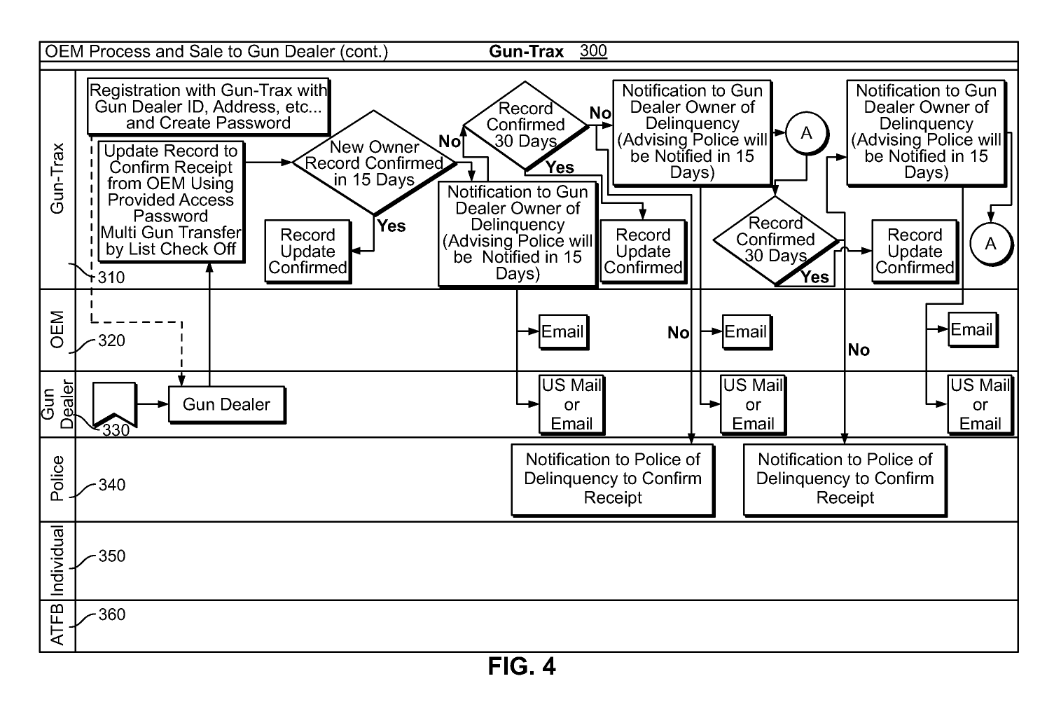

FIGS. 3 and 4 illustrate a process flow for a firearm sale between a firearm manufacturer and a firearm seller (e.g., a firearm dealer). The firearm information system 300 of an embodiment may include a tracking module 310 and a manufacturer module 320. As a preliminary matter, the manufacturer module 320 may be established for example by downloading, installing, and/or executing one or more software applications, java applets, or the like at a node 110-130 located at the manufacturer site and/or accessible by the manufacturer. For example, the manufacturer module 320 of an embodiment may be a software application executed by a personal computer geographically located at a manufacturer. Alternately or additionally, the manufacture module 320 may be a java applet or the like accessible by one or more manufacturers via network 170 (e.g., the Internet or World Wide Web). For either embodiment, the manufacturer module 320 may create and/or configure an account (e.g., a password-protected, limited-access account) for one or more manufacturers. Each manufacturer account may be associated with and/or linked to a manufacturer record established by the tracking module 310. In an embodiment, the manufacturer may be identified by name, unique numeric identifier, and/or license number (e.g., as provided by a governmental regulatory agency).

In an embodiment, for each firearm they manufacture, a registered manufacturer may provide the firearm description, serial number, one or more ballistic data, any other unique identification data, or a combination thereof, to the manufacturer module 320. The manufacturer module 320 may then communicate the firearm description, serial number, one or more ballistic data, any other unique identification data for each firearm to the tracking module 310 where it may be associated with and/or added to a record for the registered manufacturer. Accordingly, the tracking module 310 may populate and maintain information records for one or more registered manufacturers with cumulative information for the one or more firearms they produce. Alternately or additionally, the tracking module 310 may maintain individual firearm information records for each firearm that may be further associated with and/or organized by each registered manufacturer.

For the firearm description, the manufacturer may provide a model name, textual description, and/or one or more pictures or images of the firearm. For the one or more ballistic data, the manufacturer may provide a textual description of the cartridge and/or bullet and one or more images of the cartridge and/or bullet. For example, the manufacturer may provide one or more images of a once-fired cartridge to illustrate or display the firing pin mark or indentation, extractor mark or scar, gas expansion or burn pattern, or any other feature that may substantially uniquely identify the firearm in which the cartridge was fired. Further, the manufacturer may provide one or more images of the once-fired bullet to illustrate or display the marks, indentations, striations, and the like imparted by the barrel, or any other features of the bullet that may substantially uniquely identify the firearm from which bullet was fired. More specifically, the one or more images may illustrate the lands, grooves, and striations of the once-fired bullet. The manufacturer may provide any other unique identification data in a format suitable for the data.

Alternately, the manufacturer may physically provide a once-fired cartridge and/or bullet to the tracking module 310 administrator. The tracking module 310 administrator may thereafter catalogue and store the physical cartridge and/or bullet. Alternately or additionally, the tracking module 310 administrator may generate one or more images of the cartridge and/or bullet as described above that may be subsequently associated with and/or added to the firearm information or record for the registered manufacturer.

Once a registered manufacturer has established a record entry for a firearm, it may thereafter have an opportunity to add additional information to the record and/or correct the record for any errors. For example, the registered manufacturer may first create a record entry for a firearm upon the completion of its assembly and serial number assignment. Later, and after the firearm has been discharged, the registered manufacturer may append one or more ballistic data to the record for that individual firearm. To do so, the registered manufacturer may login to and/or otherwise access the manufacturer module 320 to provide the additional and/or corrected firearm information. Thereafter, the manufacturer module 320 may communicate the additional and/or corrected firearm information to the tracking module 310 after which the tracking module 310 may update the appropriate firearm record.

Once the tracking module 310 has created or generated a firearm information record for a firearm (or record entry for a manufacturer's cumulative firearm information record), firearms information system 300 may thereafter record a transfer and/or sale of the firearm from the manufacturer to a seller. For example, a manufacturer may first login to and/or otherwise access the manufacturer module 320 to update the firearm information record with information identifying the firearm seller or dealer to which the manufacturer will transfer and/or sell the firearm. The manufacture module 320 may communicate the information identifying the seller to the tracking module 310 after which the tracking module may update the appropriate firearm information record. For transfers and/or sales of multiple firearms, multiple firearm information records may be concurrently updated. For example, the manufacturer module 320 may provide the registered manufacturer with a list of firearms from which the registered manufacturer may select (e.g., by highlighting or checking a box) individual firearms to be transferred and/or sold to a specified seller. Alternately or additionally, for each firearm, the manufacturer module 320 may provide the registered manufacturer with a list of firearm sellers or dealers from which the registered manufacture may select (e.g., by highlighting and/or checking a box) a seller to transfer and/or sell the specified firearm.

After the manufacturer has updated a firearm information record with information identifying the firearm seller or dealer, the tracking module 310 may create and/or generate a notification of transfer. In an embodiment, the notification of transfer may include a password or the like. Thereafter, the tracking module 310 may physically mail the notification of transfer including the password to the firearm seller or dealer. In an embodiment, the mail may be United States Postal Service Mail. Alternately, the tracking module 310 may electronically mail the notification of transfer including the password to the firearm seller or dealer.

In the embodiment for which the tracking module 310 may physically mail the notification of transfer including the password to the firearm seller or dealer, if the United States Postal Service indicates that the mail could not be delivered to the address provided for the firearm seller or dealer, the tracking module 310 may notify the manufacturer after which the manufacturer may submit a corrected address for the firearm seller or dealer with manufacturer module 320. The tracking module 310 may physically mail a second or duplicate notification of transfer including a password. Should the mailing successfully reach a firearm seller or dealer, the tracking module 310 may update the firearm information record, manufacturer record, and/or a record including a list of acceptable or approved firearm sellers or dealers with the updated address for the firearm seller or dealer. If the mailing again fails to reach a firearm seller or dealer, the tracking module 310 may notify the manufacturer of the failure. Further, the tracking module 310 may inform law enforcement and/or a government agency, for example by communicating with law enforcement module 340 and/or government agency module 360, of the failure as it may represent a fraudulent or otherwise improperly registered firearm seller or dealer. In an embodiment, the government agency is the United States Bureau of Alcohol, Tobacco, Firearms and Explosives (ATF).

Prior to completing a firearm transfer, a firearm seller or dealer may register with the integrated firearm information system 300. For example, a seller module 330 may be established for example by a firearm seller or dealer downloading, installing, and/or executing one or more software applications, java applets, or the like at a node 110-130 located at the firearm seller's or dealer's site and/or accessible by the firearm seller or dealer. For example, the seller module 330 of an embodiment may be a software application executed by a personal computer geographically located at the firearm seller or dealer. Alternately or additionally, the seller module 330 may be a java applet or the like accessible by one or more firearm sellers or dealers via network 170 (e.g., the Internet or World Wide Web). For either embodiment, the seller module 330 may create and/or configure an account (e.g., a password-protected, limited-access account) for one or more firearm sellers or dealers. Each firearm seller or dealer account may be associated with and/or linked to a seller record established by the tracking module 310.

Having registered with the integrated firearms system 300, the registered firearm seller or dealer may login to and/or otherwise access the seller module 330 and may communicate the password received in the notification of transfer to the tracking module 310. Thereafter, the registered firearm seller or dealer may approve the transfer of one or more firearms, for example by highlighting or checking a box for each of the one or more firearms included in a list of firearms established by the registered manufacturer for that particular firearm seller or dealer. Provided the registered firearm seller or dealer approves the transfer within a determined amount of time (in an embodiment, 15 days), the registered manufacturer may physically transfer the one or more firearms to the registered firearm seller or dealer, for example in compliance with any additional local or federal rules governing the transfer of firearms. The firearm information record associated with each transferred firearm may be updated by tracking module 310 to indicate the new possession and/or ownership of the firearm by the registered firearm seller or dealer. For example, the tracking module 310 may further process the transfer with the law enforcement module 340 and/or government agency module 360 in compliance with any local and/or government agency rules.

If the registered firearm seller or dealer does not confirm the transfer as described above with the determined time (in an embodiment, 15 days) the tracking module 310 may notify the registered firearm seller or dealer of their delinquency via physical mail and/or electronic mail and provide an additional time period (in an embodiment, 15 days) to confirm the transfer. Substantially concurrently, the tracking module 310 may notify the registered manufacturer of the registered firearm seller's or dealer's delinquency via physical mail and/or electronic mail. Following the first notification of delinquency, the registered firearm seller or dealer may have a determined amount of time (in an embodiment, 30 days total or 15 days from the firearm seller's or dealer's first delinquency notice) to confirm the transfer. If the firearm seller or dealer fails to confirm the transfer a second time, the tracking module 310 may again notify the registered firearm seller or dealer of their second delinquency via physical mail and/or electronic mail. Substantially concurrently, the tracking module 310 may notify the registered manufacturer of the registered firearm seller's or dealer's second delinquency via physical mail and/or electronic mail. Additionally, the tracking module 310 may inform law enforcement, for example by communicating with law enforcement module 340 of the firearm seller's or dealer's second delinquency. Additional periods of delinquency and reporting to the registered manufacturer, registered firearm seller or dealer, and/or law enforcement may occur until the registered firearm seller or dealer confirms the transfer or otherwise cancels the transfer.

Firearm Seller or Dealer Sale to Individual Process

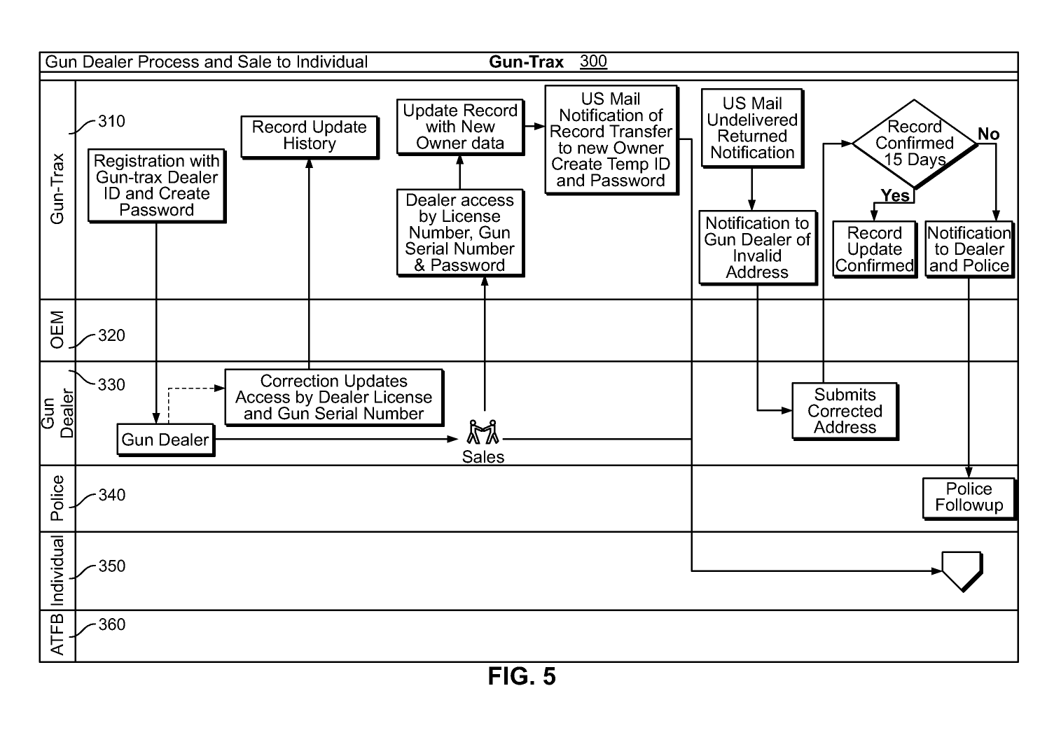

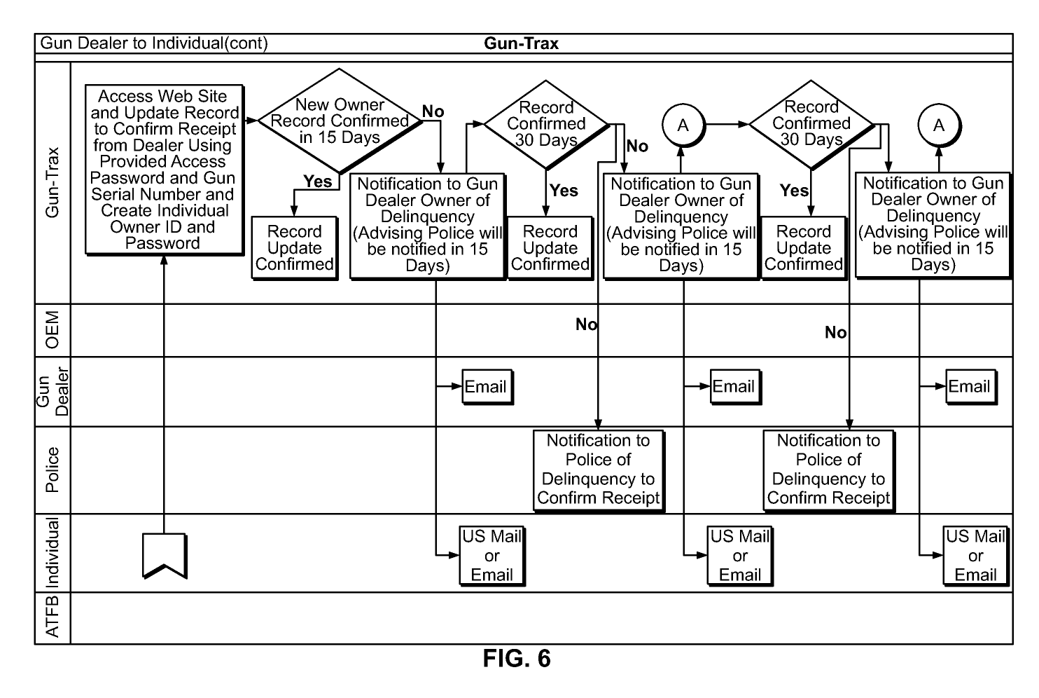

FIGS. 5 and 6 illustrate a process flow for a firearm sale between a firearm dealer and an individual. Having received one or more transferred firearms, the registered firearm seller or dealer may first have the opportunity to correct any errors that may be present in the firearm information record maintained by the tracking module 310. Thereafter, to accomplish a sale to an individual, the firearm seller or dealer may first login to and/or otherwise access the seller module 330 to update the firearm information record with information identifying the individual to whom the firearm seller or dealer will transfer and/or sell the firearm. The seller module 330 may communicate the information identifying the individual to the tracking module 310 after which the tracking module 310 may update the appropriate firearm information record. For transfers and/or sales of multiple firearms, multiple firearm information records may be concurrently updated. For example, the seller module 330 may provide the registered firearm seller or dealer with a list of firearms from which the registered firearm seller or dealer may select (e.g., by highlighting or checking a box) individual firearms to be transferred and/or sold to a specified individual. Alternately or additionally, for each firearm, the seller module 330 may provide the registered firearm seller or dealer with a list of individuals from which the registered firearm seller or dealer may select (e.g., by highlighting and/or checking a box) an individual to transfer and/or sell the specified firearm. For example, the list of individuals may include a list of registered individuals who have previously registered with the integrated firearm information system 300.

After the firearm seller or dealer has updated a firearm information record with information identifying the individual, the tracking module 310 may create and/or generate a notification of transfer. In an embodiment, the notification of transfer may include a password or the like. Thereafter, the tracking module 310 may physically mail the notification of transfer including the password to the individual. In an embodiment, the mail may be United States Postal Service Mail. Alternately, the tracking module 310 may electronically mail the notification of transfer including the password to the individual.

In the embodiment for which the tracking module 310 may physically mail the notification of transfer including the password to the individual, if the United States Postal Service indicates that the mail could not be delivered to the address provided for the individual, the tracking module 310 may notify the firearm seller or dealer after which the firearm seller or dealer may submit a corrected address for the individual, for example to seller module 330. The tracking module 310 may physically mail a second or duplicate notification of transfer including a password. Should the mailing successfully reach the individual, the tracking module 310 may update the firearm information record, manufacturer record, firearm seller or dealer record, and/or a record including a list of acceptable or approved individuals including the updated address for the individual. If the mailing again fails to reach the individual, the tracking module 310 may notify the firearm seller or dealer of the failure. Further, the tracking module 310 may inform law enforcement and/or a government agency, for example by communicating with law enforcement module 340 and/or government agency module 360, of the failure as it may represent a fraudulent or otherwise improperly registered individual. In an embodiment, the government agency is the United States Bureau of Alcohol, Tobacco, Firearms and Explosives (ATF).

Prior to completing a firearm transfer, the individual may register with the integrated firearm information system 300. For example, an individual module 350 may be established for example by an individual downloading, installing, and/or executing one or more software applications, java applets, or the like at a node 110-130 located at the individual's site and/or accessible by the individual. For example, the individual module 350 of an embodiment may be a software application executed by a personal computer geographically co-located with the individual. Alternately or additionally, the individual module 350 may be a java applet or the like accessible by one or more individuals via network 170 (e.g., the Internet or World Wide Web). For either embodiment, the individual module 350 may create and/or configure an account (e.g., a password-protected, limited-access account) for one or more individuals. Each individual account may be associated with and/or linked to an individual record established by the tracking module 310.

Having registered with the integrated firearms system 300, the individual may login to and/or otherwise access the individual module 350 and may communicate the password received in the notification of transfer to the tracking module 310. Thereafter, the individual may approve the transfer of one or more firearms, for example by highlighting or checking a box for each of the one or more firearms included in a list of firearms established by the firearm seller or dealer for that particular individual. Provided the registered individual approves the transfer within a determined amount of time (in an embodiment, 15 days), the registered firearm seller or dealer may physically transfer the one or more firearms to the registered individual, for example in compliance with any additional local or federal rules governing the transfer of firearms. The firearm information record associated with each transferred firearm may be updated by tracking module 310 to indicate the new possession and/or ownership of the firearm by the registered individual. For example, the tracking module 310 may further process the transfer with the law enforcement module 340 and/or government agency module 360 in compliance with any local and/or government agency rules.

If the individual does not confirm the transfer as described above with the determined time (in an embodiment, 15 days) the tracking module 310 may notify the individual of their delinquency via physical mail and/or electronic mail and provide an additional time period (in an embodiment, 15 days) to confirm the transfer. Substantially concurrently, the tracking module 310 may notify the registered firearm seller or dealer of the individual's delinquency via physical mail and/or electronic mail. Following the first notification of delinquency, the individual may have a determined amount of time (in an embodiment, 30 days total or 15 days from the individual's first delinquency notice) to confirm the transfer. If the individual fails to confirm the transfer a second time, the tracking module 310 may again notify the individual of their second delinquency via physical mail and/or electronic mail. Substantially concurrently, the tracking module 310 may notify the registered firearm seller or dealer of the registered individual's second delinquency via physical mail and/or electronic mail. Additionally, the tracking module 310 may inform law enforcement, for example by communicating with law enforcement module 340 of the individual's second delinquency. Additional periods of delinquency and reporting to the individual, registered firearm seller or dealer, and/or law enforcement may occur until the individual confirms the transfer or otherwise cancels the transfer.

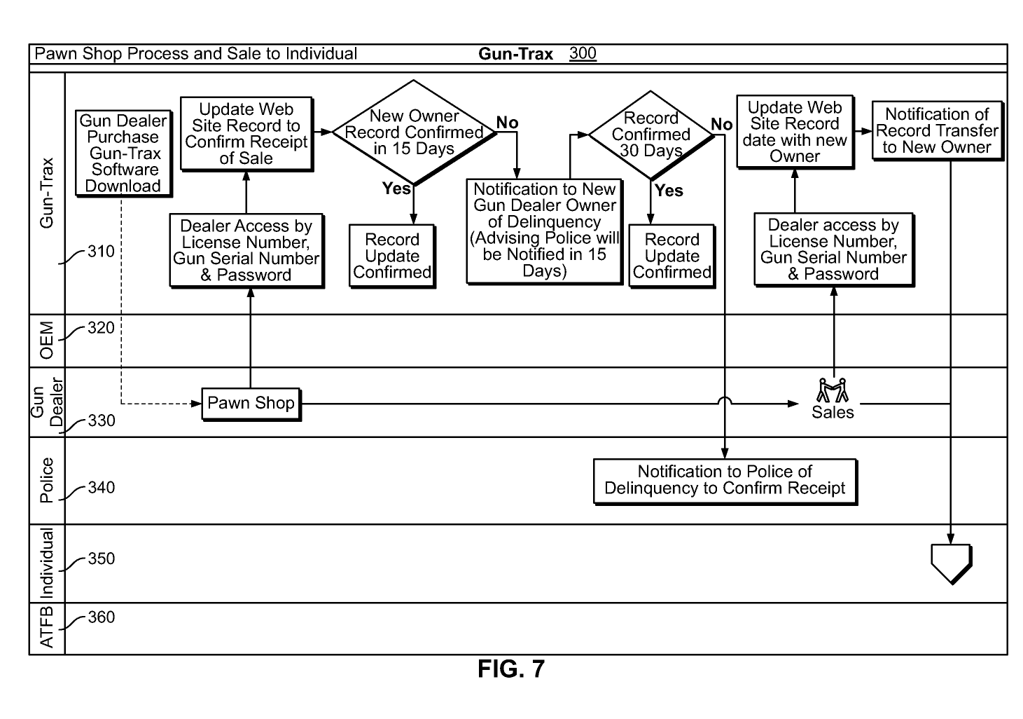

FIG. 7. illustrates the process flow for a firearm sale between a pawn shop and an individual. The process for a pawn shop to sell a firearm to an individual is substantially similar to the process for a firearm seller or dealer to sell a firearm to an individual as described with reference to FIGS. 5 and 6.

Individual Sale to Pawn Shop Process

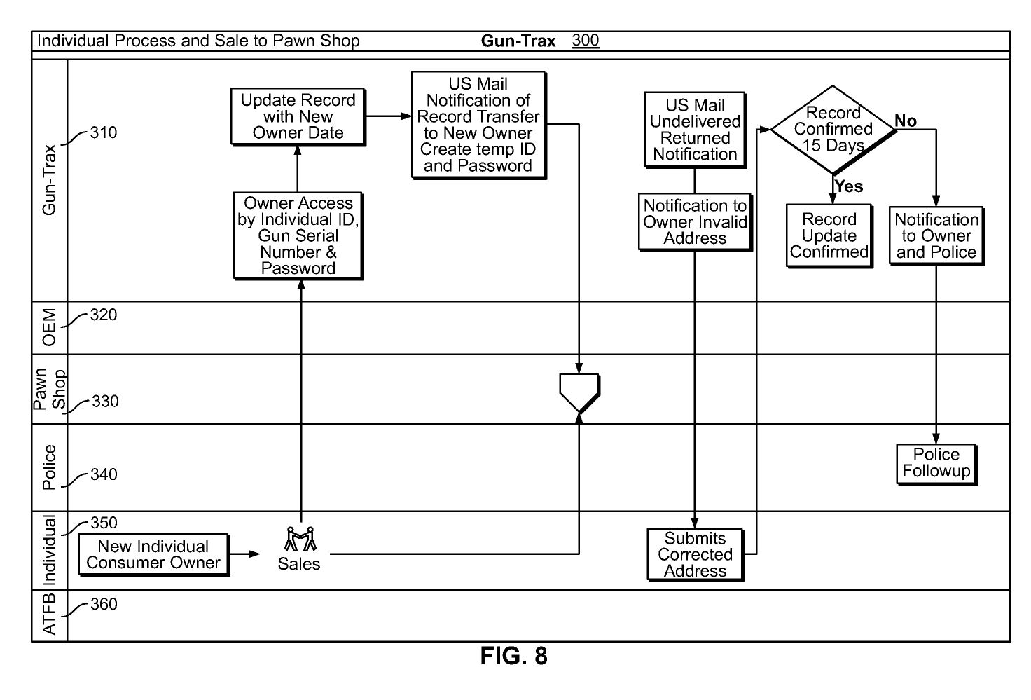

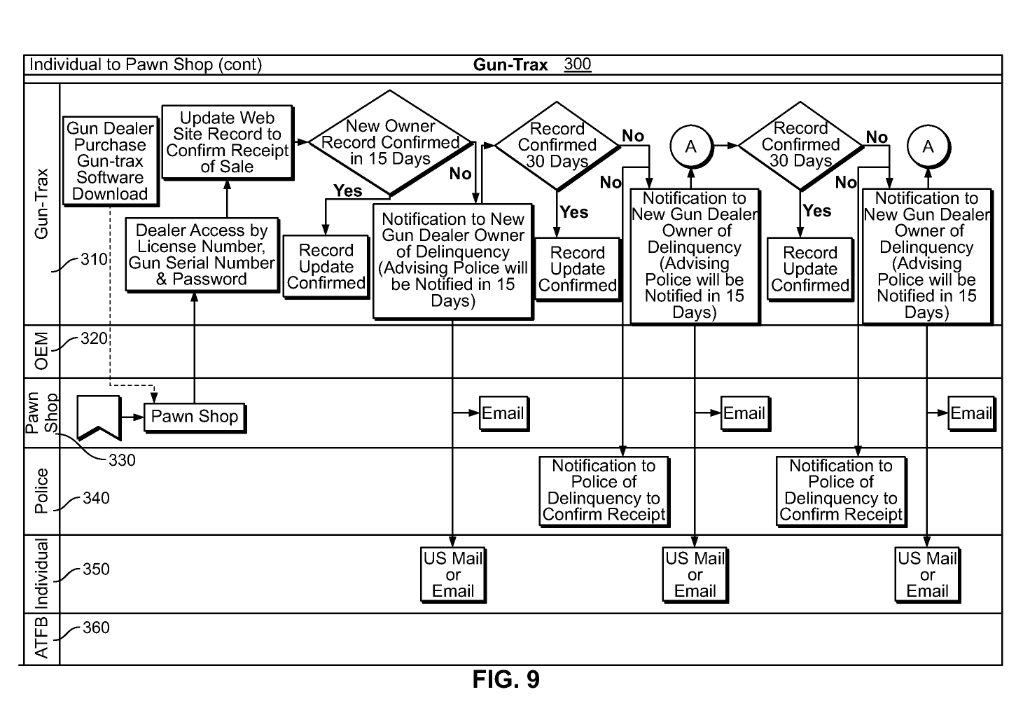

FIGS. 8 and 9 illustrate a process flow for a firearm sale between an individual and a pawn shop. More specifically, FIGS. 8 and 9 illustrate a process flow for a firearm sale from an individual to a pawn shop. As a preliminary matter, the process as described assumes that the individual's firearm has an existing firearm information record with the tracking module 310. To accomplish a sale to a pawn shop, the individual may first login to and/or otherwise access the individual module 350 to update the firearm information record with information identifying the pawn shop to which the individual will transfer and/or sell the firearm. The individual module 350 may communicate the information identifying the pawn shop to the tracking module 310 after which the tracking module 310 may update the appropriate firearm information record. For transfers and/or sales of multiple firearms, multiple firearm information records may be concurrently updated. For example, individual module 350 may provide the registered individual with a list of firearms they have previously registered from which the registered individual may select (e.g., by highlighting or checking a box) individual firearms to be transferred and/or sold to a specified pawn shop. Alternately or additionally, for each firearm, the individual module 350 may provide the registered individual with a list of pawn shops from which the registered individual may select (e.g., by highlighting and/or checking a box) a pawn shop to transfer and/or sell the specified firearm. For example, the list of pawn shops may include a list of registered pawn shops that have previously registered with the integrated firearm information system 300.

After the individual has updated a firearm information record with information identifying the pawn shop, the tracking module 310 may create and/or generate a notification of transfer. In an embodiment, the notification of transfer may include a password or the like. Thereafter, the tracking module 310 may physically mail the notification of transfer including the password to the pawn shop. In an embodiment, the mail may be United States Postal Service Mail. Alternately, the tracking module 310 may electronically mail the notification of transfer including the password to the pawn shop.

In the embodiment for which the tracking module 310 may physically mail the notification of transfer including the password to the pawn shop, if the United States Postal Service indicates that the mail could not be delivered to the address provided for the pawn shop, the tracking module 310 may notify the individual after) which the individual may submit a corrected address for the pawn shop, for example to individual module 350. The tracking module 310 may physically mail a second or duplicate notification of transfer including a password. Should the mailing successfully reach the pawn shop, the tracking module 310 may update the firearm information record, individual record, and/or a record including a list of acceptable or approved pawn shops including the updated address for the pawn shop. If the mailing again fails to reach the individual, the tracking module 310 may notify the individual of the failure. Further, the tracking module 310 may inform law enforcement and/or a government agency, for example by communicating with law enforcement module 340 and/or government agency module 360, of the failure as it may represent a fraudulent or otherwise improperly registered pawn shop. In an embodiment, the government agency is the United States Bureau of Alcohol, Tobacco, Firearms and Explosives (ATF).

Prior to completing a firearm transfer, the pawn shop may register with the integrated firearm information system 300. For example, a pawn shop module 370 may be established for example by pawn shop downloading, installing, and/or executing one or more software applications, java applets, or the like at a node 110-130 located at the pawn shop's site and/or accessible by the pawn shop. For example, the pawn shop module 370 of an embodiment may be a software application executed by a personal computer, geographically located at the pawn shop. Alternately or additionally, the pawn shop module 370 may be a java applet or the like accessible by one or more pawn shops via network 170 (e.g., the Internet or World Wide Web). For either embodiment, the pawn shop module 370 may create and/or configure an account (e.g., a password-protected, limited-access account) for one or more pawn shops. Each pawn shop account may be associated with and/or linked to pawn shop record established by the tracking module 310.

Having registered with the integrated firearms system 300, the pawn shop may login to and/or otherwise access the pawn shop 370 and may communicate the password received in the notification of transfer to the tracking module 310. Thereafter, the pawn shop may approve the transfer of one or more firearms, for example by highlighting or checking a box for each of the one or more firearms included in a list of firearms established by the individual for that particular pawn shop. Provided the registered pawn shop approves the transfer within a determined amount of time (in an embodiment, 15 days), the registered individual may physically transfer the one or more firearms to the registered pawn shop, for example in compliance with any additional local or federal rules governing the transfer of firearms. The firearm information record associated with each transferred firearm may be updated by tracking module 310 to indicate the new possession and/or ownership of the firearm by the registered pawn shop. For example, the tracking module 310 may further process the transfer with the law enforcement module 340 and/or government agency module 360 in compliance with any local and/or government agency rules.

If the pawn shop does not confirm the transfer as described above with the determined time (in an embodiment, 15 days) the tracking module 310 may notify the pawn shop of their delinquency via physical mail and/or electronic mail and provide an additional time period (in an embodiment, 15 days) to confirm the transfer. Substantially concurrently, the tracking module 310 may notify the individual of the pawn shop's delinquency via physical mail and/or electronic mail. Following the first notification of delinquency, the pawn shop may have a determined amount of time (in an embodiment, 30 days total or 15 days from the pawn shop's first delinquency notice) to confirm the transfer. If the pawn shop fails to confirm the transfer a second time, the tracking module 310 may again notify the pawn shop of their second delinquency via physical mail and/or electronic mail. Substantially concurrently, the tracking module 310 may notify the registered individual of the registered pawn shop's second delinquency via physical mail and/or electronic mail. Additionally, the tracking module 310 may inform law enforcement, for example by communicating with law enforcement module 340 of the pawn shop's second delinquency. Additional periods of delinquency and reporting to the pawn shop, individual, and/or law enforcement may occur until the pawn shop confirms the transfer or otherwise cancels the transfer.

Individual Sale to Individual Process

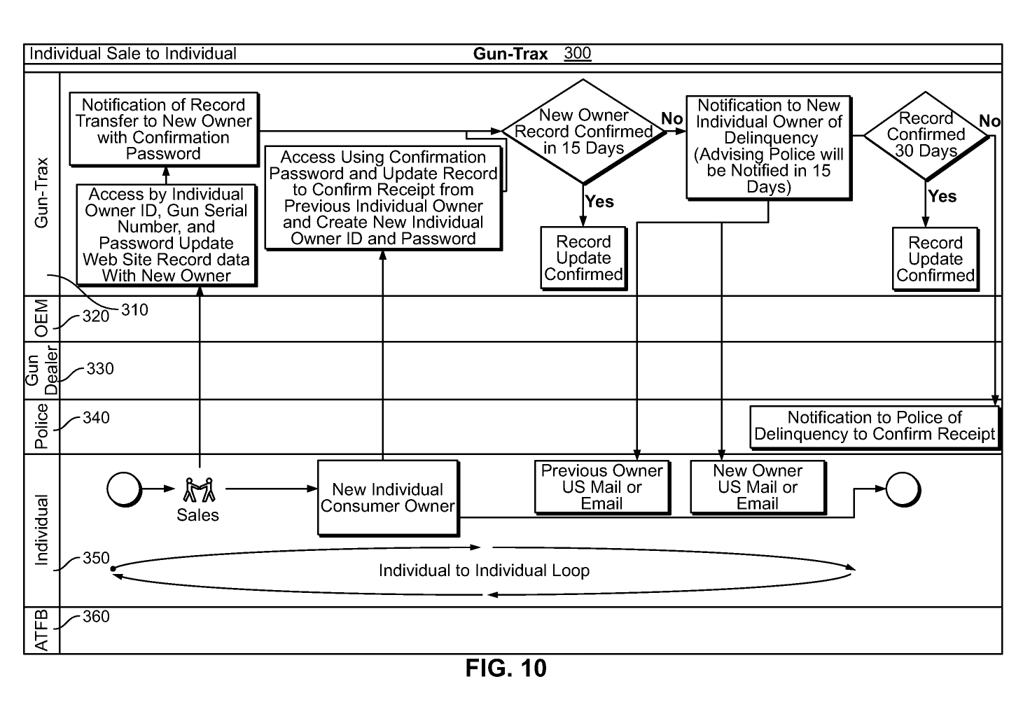

FIG. 10 illustrates a process flow for a firearm transfer and/or sale between two individuals. As a preliminary matter, the process as described assumes that the first individual's firearm has an existing firearm information record with the tracking module 310. To accomplish a sale to a second individual, the first individual may first login to and/or otherwise access the individual module 350 to update the firearm information record with information identifying the second individual to whom the individual will transfer and/or sell the firearm. The individual module 350 may communicate the information identifying the second individual to the tracking module 310 after which the tracking module 310 may update the appropriate firearm information record. For transfers and/or sales of multiple firearms, multiple firearm information records may be concurrently updated. For example, individual module 350 may provide the registered first individual with a list of firearms they have previously registered from which the registered first individual may select (e.g., by highlighting or checking a box) individual firearms to be transferred and/or sold to a specified second individual. Alternately or additionally, for each firearm, the individual module 350 may provide the registered first individual with a list of second individuals from which the registered first individual may select (e.g., by highlighting and/or checking a box) a second individual to transfer and/or sell the specified firearm. For example, the list of second individuals may include a list of all individuals that have previously registered with the integrated firearm information system 300.

After the first individual has updated a firearm information record with information identifying the second individual, the tracking module 310 may create and/or generate a notification of transfer. In an embodiment, the notification of transfer may include a password or the like. Thereafter, the tracking module 310 may physically mail the notification of transfer including the password to the second individual. In an embodiment, the mail may be United States Postal Service Mail. Alternately, the tracking module 310 may electronically mail or otherwise electronically communicate the notification of transfer including the password to the second individual.

In the embodiment for which the tracking module 310 may physically mail the notification of transfer including the password to the second individual, if the United States Postal Service indicates that the mail could not be delivered to the address provided for the second individual, the tracking module 310 may notify the first individual after which the first individual may submit a corrected address for the pawn shop, for example to individual module 350. The tracking module 310 may physically mail a second or duplicate notification of transfer including a password. Should the mailing successfully reach the second individual, the tracking module 310 may update the firearm information record, first and/or second individual record(s), and/or a record including a list of acceptable or approved individuals including the updated address for the second individual. If the mailing again fails to reach the second individual, the tracking module 310 may notify the first individual of the failure. Further, the tracking module 310 may inform law enforcement and/or a government agency, for example by communicating with law enforcement module 340 and/or government agency module 360, of the failure as it may represent a fraudulent or otherwise improperly registered second individual. In an embodiment, the government agency is the United States Bureau of Alcohol, Tobacco, Firearms and Explosives (ATF).

Prior to completing the firearm transfer, the second individual may register with the integrated firearm information system 300. For example, another individual module 350 may be established for example by the second individual downloading, installing, and/or executing one or more software applications, java applets, or the like at a node 110-130 co-located with the second individual and/or accessible by the second individual as described above. Alternately or additionally, the individual module 350 may be a java applet or the like accessible by the second individual via network 170 (e.g., the Internet or World Wide Web). For either embodiment, the individual module 350 may create and/or configure an account (e.g., a password-protected, limited-access account) for the second individual.

Having registered with the integrated firearms system 300, the second individual may login to and/or otherwise access the individual module 350 and may communicate the password received in the notification of transfer to the tracking module 310. Thereafter, the second individual may approve the transfer of one or more firearms, for example by highlighting or checking a box for each of the one or more firearms included in a list of firearms established by the first individual for that particular transaction. Provided the registered second individual approves the transfer within a determined amount of time (in an embodiment, 15 days), the registered first individual may physically transfer the one or more firearms to the registered second individual, for example in compliance with any additional local or federal rules governing the transfer of firearms between individuals. The firearm information record associated with each transferred firearm may be updated by tracking module 310 to indicate the new possession and/or ownership of the firearm by the registered second individual. For example, the tracking module 310 may further process the transfer with the law enforcement module 340 and/or government agency module 360 in compliance with any local and/or government agency rules.

If the second individual does not confirm the transfer as described above with the determined time (in an embodiment, 15 days) the tracking module 310 may notify the second individual of their delinquency via physical mail and/or electronic mail and provide an additional time period (in an embodiment, 15 days) to confirm the transfer. Substantially concurrently, the tracking module 310 may notify the first individual of the second individual's delinquency via physical mail and/or electronic mail. Following the first notification of delinquency, the second individual may have a determined amount of time (in an embodiment, 30 days total or 15 days from the second individual's first delinquency notice) to confirm the transfer. If the second individual fails to confirm the transfer a second time, the tracking module 310 may again notify the second individual of their second delinquency via physical mail and/or electronic mail. Substantially concurrently, the tracking module 310 may notify the first individual of the second individual's second delinquency via physical mail and/or electronic mail. Additionally, the tracking module 310 may inform law enforcement, for example by communicating with law enforcement module 340 of the second individual's second delinquency. Additional periods of delinquency and reporting to the second individual, first individual, and/or law enforcement may occur until the second individual confirms the transfer or otherwise cancels the transfer.

Individual Registration of Existing Firearm

The above mentioned processes including transactions with individual firearm owners assume that the individual's firearm has an existing firearm information record with the tracking module. Such would be the case if the firearm manufacturer had registered the firearm with the integrated firearm information system 300 and if the firearm information record reflected one or more ownership and/or possession transactions (e.g., transfers between and among firearm manufacturers, firearm sellers or dealers, individual owners, pawn shops, and the like).

If the firearm is not registered with the integrated firearm information system, the individual owning the firearm may first register with the integrated firearm information system 300. For example, an individual module 350 may be established for example by an individual downloading, installing, and/or executing one or more software applications, java applets, or the like at a node 110-130 located at the individual's site and/or accessible by the individual. For example, the individual module 350 of an embodiment may be a software application executed by a personal computer geographically co-located with the individual. Alternately or additionally, the individual module 350 may be a java applet or the like accessible by one or more individuals via network 170 (e.g., the Internet or World Wide Web). For either embodiment, the individual module 350 may create and/or configure an account (e.g., a password-protected, limited-access account) for one or more individuals. Each individual account may be associated with and/or linked to an individual record established by the tracking module 310

Thereafter, the registered individual may register one or more firearms in their possession. In an embodiment, for each firearm they own, a registered individual may provide the firearm description, serial number, one or more ballistic data, any other unique identification data, or a combination thereof, to the individual module 350. The individual module 350 may then communicate the firearm description, serial number, one or more ballistic data, any other unique identification data for each firearm to the tracking module 310 where it may be associated with and/or added to a new record for each firearm. Accordingly, the tracking module 310 may populate and maintain information records for one or more registered individuals with cumulative information for the one or more firearms they own. Alternately or additionally, the tracking module 310 may maintain individual firearm information records for each firearm that may be further associated with and/or organized by each registered individual.

For the firearm description, the individual may provide a model name, textual description, and/or one or more pictures or images of the firearm. For the one or more ballistic data, the individual may provide a textual description of the cartridge and/or bullet and one or more images of the cartridge and/or bullet. For example, the individual may provide one or more images of a once-fired cartridge to illustrate or display the firing pin mark or indentation, extractor mark or scar, gas expansion or burn pattern, or any other feature that may substantially uniquely identify the firearm in which the cartridge was fired. Further, the individual may provide one or more images of the once-fired bullet to illustrate or display the marks, indentations, striations, and the like imparted, by the barrel, or any other features of the bullet that may substantially uniquely identify the firearm from which bullet was fired. More specifically, the one or more images may illustrate the lands, grooves, and striations of the once-fired bullet. The individual may provide any other unique identification data in a format suitable for the data.

Alternately, the individual may physically provide a once-fired cartridge and/or bullet to the tracking module 310 administrator. The tracking module 310 administrator may thereafter catalogue and store the physical cartridge and/or bullet. Alternately or additionally, the tracking module 310 administrator may generate one or more images of the cartridge and/or bullet as described above that may be subsequently associated with and/or added to the firearm information or record for the registered manufacturer.

Once a registered individual has established a record entry for a firearm, they may thereafter have an opportunity to add additional information to the record and/or correct the record for any errors. To do so, the registered individual may login to and/or otherwise access the individual module 350 to provide the additional and/or corrected firearm information. Thereafter, the individual module 350 may communicate the additional and/or corrected firearm information to the tracking module 310 after which the tracking module 310 may update the appropriate firearm record.

Further, though described with reference to an individual registering himself and/or one or more firearms they own and/or possess, substantially the same process may be used by any entity owning and/or possessing a firearm that does not have a firearm information record established with the integrated firearm information system 300. For example, a firearm seller or dealer, pawn shop, or the like, may register themselves and/or one or more firearms they own and/or possess that are part of an existing firearm inventory.

The registration of an existing firearm with the integrated firearm information database 300 by an entity may provide the entity with the ability to check the transfer and/or ownership history of the firearm, to generate a transfer and/or ownership history of the firearm for subsequent transfers and/or ownership transactions, and to utilize the tracking processes of the integrated firearm information database 300 in case of theft, loss, or the like.

Police Find Firearm Process

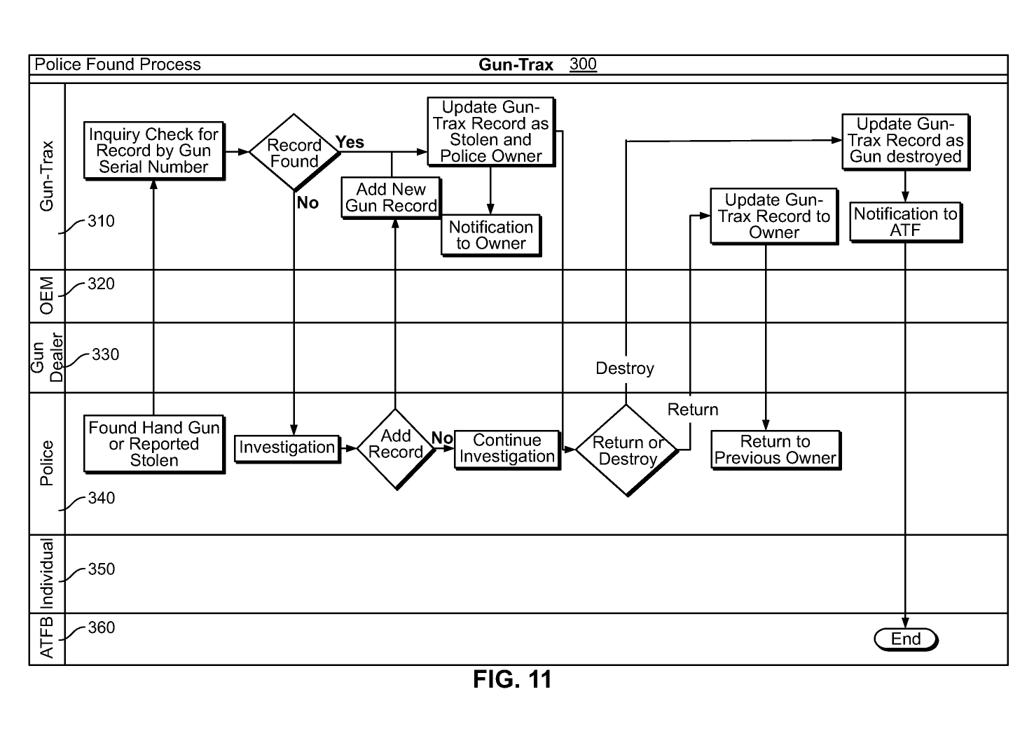

FIG. 11 illustrates a process flow for law enforcement finding a firearm. More generally, the process may be applied to any possession and/or obtainment of an unknown firearm by a law enforcement agency. For example, law enforcement may locate a firearm as part of a crime scene, may obtain a firearm pending the resolution of a domestic violence dispute or association therewith, or may confiscate a firearm from an unlawful possessor. The embodiments are not limited in this context.

Once a firearm has been obtained by a law enforcement agency, provided the law enforcement agency has an account and/or is otherwise registered with the integrated firearm information system 300, the law enforcement agency may login to and/or otherwise access the law enforcement module 340. If they do not have an account, the law enforcement agency may create an account and/or otherwise register for the integrated firearm information system 300 as described above with respect to the manufacturer, firearm seller or dealer, individual, and pawn shop.

Having logged into the integrated firearm information system 300, for example through law enforcement module 340, the law enforcement agency may search for the obtained firearm, for example by serial number, description, or the like. In an embodiment, the law enforcement agency may perform a search using only the firearm's serial number. If the found firearm's serial number matches an existing firearm information record, the integrated firearm information system 300 may update the firearm information record to reflect the possession of the firearm by the law enforcement agency. If the found firearm is itself and/or includes evidence of a crime, or is part of an ongoing criminal investigation, the firearm information record may be updated to further reflect that the law enforcement agency is the current owner of the found firearm. The integrated firearm information system 300 may concurrently or thereafter notify the last owner and/or possessor recorded in the firearm information record that their firearm has been located, confiscated, and/or otherwise obtained by the law enforcement agency. If the integrated firearm information system 300 does not have record of the found firearm, the law enforcement agency may create a new account and/or record for the firearm as described above.

Depending on the nature of the law enforcement agency's involvement with the found firearm, the law enforcement agency may retain the found firearm (e.g., to destroy it, as evidence, part of an ongoing investigation, or because the owner may not lawfully own and/or possess the firearm) or may return the found firearm to its lawful owner. If the law enforcement agency chooses to destroy the found firearm, the law enforcement agency may update the firearm information record, for example with law enforcement module 340, to indicate that the firearm has been destroyed. The tracking module 310 may thereafter notify one or more government agencies of the firearm's destruction, for example by communicating with government agency module 360. In an embodiment, the government agency is the United States Bureau of Alcohol, Tobacco, Firearms and Explosives (ATF).

If the law enforcement agency chooses to return the found firearm to the last owner identified by the integrated firearm information system 300, the law enforcement agency may first, for example by connecting with and/or logging into law enforcement module 340, create and/or update the firearm information record to indicate that the found firearm will be returned to its owner. If the owner is registered with the integrated firearm information system 300, the law enforcement agency may simply transfer the firearm back to the owner in accordance with local and federal laws. If the owner is not currently registered with the integrated firearm information system 300, the creation of a firearm information record by the law enforcement agency may initiate an invitation for the firearm owner to register with the integrated firearm information system.

Report of Stolen Process

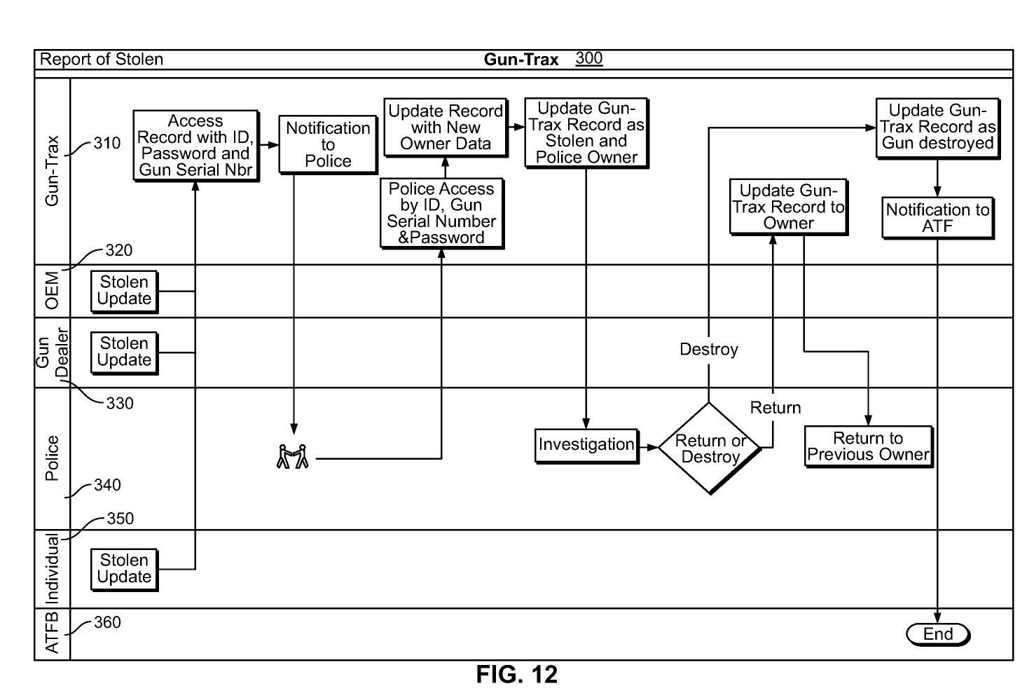

FIG. 12 illustrates a process flow for law enforcement receiving a report of a stolen firearm. The report of a stolen firearm may originate from anyone or any entity that owns and/or possesses the firearm. For example, the report may originate from a firearm manufacturer, a firearm seller/dealer, a pawn shop, an individual firearm owner, or any other individual or entity. In an embodiment for which the firearm manufacturer, a firearm seller/dealer, a pawn shop, or an individual firearm owner have created an account or otherwise registered with integrated firearm information system 300, each may login to and/or otherwise access manufacturer module 320, the seller module 330, the pawn shop module 370, and the individual module 350 respectively and access the firearm information record. In an embodiment, the firearm information record may be accessed by providing login identification (e.g., a unique ID or user name), password, and the stolen firearm's serial number after which the firearm information record may be tagged with indication that the firearm has been stolen.

Once the firearm information record has been tagged with indication that the firearm has been stolen, the tracking module 310 may contact and/or otherwise notify a law enforcement agency that the firearm has been stolen. In an embodiment for which the law enforcement agency is registered with the integrated firearm information system, the tracking module 310 may contact and/or otherwise notify the law enforcement agency by communicating with law enforcement module 340. Alternately or additionally, the tracking module 310 may initiate any electronic and/or physical communication means to notify the law enforcement agency of the theft. In an embodiment, the tracking module 310 may select the law enforcement agency that is local for and/or otherwise corresponds to the physical location or address of the firearm manufacturer, firearm seller/dealer, pawn shop, or individual reporting the stolen firearm. Having been notified of the firearm theft, the law enforcement agency may thereafter conduct an investigation according to its investigatory standards.

If the law enforcement agency locates and/or otherwise obtains the firearm reported stolen, provided the law enforcement agency has an account and/or is otherwise registered with the integrated firearm information system 300, the law enforcement agency may login to and/or otherwise access the law enforcement module 340. If they do not have an account, the law enforcement agency may create an account and/or otherwise register for the integrated firearm information system 300 as described above with respect to the manufacturer, firearm seller/dealer, pawn shop, and individual.

Having logged into the integrated firearm information system 300, for example through law enforcement module 340, the law enforcement agency may search for the obtained firearm, for example by serial number, description, or the like. In an embodiment, the law enforcement agency may perform a search using only the firearm's serial number. Having located the firearm information record for the recovered firearm, the law enforcement agency may update the firearm information record to indicate that they are the current owner and/or possessor of the recovered firearm.

Depending on the nature of the law enforcement agency's involvement with the recovered firearm, the law enforcement agency may retain the recovered firearm (e.g., to destroy it, as evidence, part of an ongoing investigation, or because the owner may not lawfully own and/or possess the firearm) or may return the found firearm to its lawful owner. If the law enforcement agency chooses to destroy the found firearm, the law enforcement agency may update the firearm information record, for example with law enforcement module 340, to indicate that the firearm has been destroyed. The tracking module 310 may thereafter notify one or more government agencies of the firearm's destruction, for example by communicating with government agency module 360. In an embodiment, the government agency is the United States Bureau of Alcohol, Tobacco, Firearms and Explosives (ATF).

If the law enforcement agency chooses to return the found firearm to the last owner identified by the integrated firearm information system 300, the law enforcement agency may first, for example by logging into and/or otherwise accessing law enforcement module 340, update the firearm information record to indicate that the recovered firearm will be returned to its owner. As the owner is registered with the integrated firearm information system 300 (having reported the firearm as stolen through integrated firearm information system 300), the law enforcement agency may simply transfer the recovered firearm back to the owner in accordance with local and federal laws.

Manufacturer Notices and Recall

In addition to the information described above that in an embodiment comprises a firearm information record, the integrated firearm information system 300 may further distribute important information regarding a firearm registered therewith to any subsequent purchaser or transferee. For example, subsequent to manufacturing and selling one or more firearms, for example to one or more firearm sellers/dealers, a manufacturer may issue a recall notice or any other notice related to firearm safety, warranty, proper use, and/or upgrades and accessories available for the firearm to the current owner and/or possessor of the registered firearm. As the integrated firearm information system 300 includes a record for each registered firearm including the chain of title and most recent owner and/or possessor, the manufacturer may login to and/or otherwise access the manufacturer module 320 and indicate one or more registered firearms (e.g., by identifying the firearm by serial number, model, type, date of manufacture, or any other means of identification) for which the manufacturer wishes to issue a notice. In an embodiment, the manufacturer may select one or more registered firearms and/or groups of registered firearms for which they wish to issue a notice from a list, drop-down menu, or the like. Having selected the one or more registered firearms, the manufacturer may further provide (e.g., by uploading to manufacturer module 320) the notice document to be distributed. Additionally or alternately, the manufacturer may select a notice type from a list, drop-down menu, or the like. Once the manufacturer has provided the notice to the manufacturer module, the tracking module 310 may electronically and/or physically distribute the notice to the last owner and/or possessor identified by the firearm information records. In an embodiment, depending on the notice type, the tracking module 310 of an embodiment may electronically and/or physically distribute the notice to additional owners and/or possessors identified by the firearm information records. For example, the tracking module 310 may distribute a recall notice to the individual owner and/or possessor of record and the firearm seller/dealer of record from whom the individual purchased the firearm. Such may be the case if the manufacturer instructs the individual to return the recalled firearm to the firearm seller/dealer and/or if the recall applies to a group of registered firearms that at least partially remain in the firearm seller's/dealer's inventory. The embodiments are not limited in this context.

Individual Research of Existing Firearm

In addition to the various methods and system modules described above, the integrated firearm information system 300 may further serve as a research tool. For example, it is not uncommon for an individual to purchase and/or sell firearms at gun shows or the like that may not be subject to the same stringent firearm transfer laws as a manufacturer and/or licensed firearm seller/dealer. In such a situation, an individual may wish to research the firearm they wish to purchase or sell prior to completing the transaction. For example, through a guest account and/or by registering with the integrated firearm information system 300 of an embodiment, an individual interested in purchasing a firearm may search the tracking module 310 for any records related to the firearm. While the amount and/or type of information that may be available to the individual may vary as will be described below with reference to privacy and security, the tracking module 310 may provide at least an indication, flag, or the like, that the firearm may require additional research, for example with the help of law enforcement, prior to purchase.

Privacy and Security

The implementation of the integrated firearm information system 300 of an embodiment may depend on its voluntary acceptance and use by a variety of stakeholders (e.g., manufacturers, firearm sellers/dealers, pawn shops, law enforcement agencies, government agencies, individual firearm owners, and/or any other stakeholder). Given the nature of firearm manufacturing and ownership, stakeholders are likely to embrace the benefits of the integrated firearm information system 300 of an embodiment more enthusiastically provided they are substantially assured that the firearm information records remain substantially confidential. Simply stated, the integrated firearm information system 300 of an embodiment may be configured to collect, monitor, transfer, and disseminate the information it collects in accordance with privacy rules and policies consistent with or stricter than the expectation of privacy a manufacturer, firearm seller/dealer, pawn shop, and/or individual may have for that information.

Of particular concern may be a law enforcement or government agency's access to the firearm information records and/or listing of registered gun owners. As such, the record keeping nature of the integrated firearm information system 300 may include features, functionality, and privacy elements to substantially ensure that the integrated firearm information system 300 does not act as, nor appear to act as, another layer of law enforcement or government oversight and monitoring. Accordingly, the law enforcement agencies and government agencies involved with firearm manufacture, transfer, ownership, and/or possession may have substantially limited access to the information maintained by the integrated information system 300 of an embodiment, or may have access only at the direction or order of a court of applicable jurisdiction. For example, when a law enforcement agency finds, locates, or otherwise obtains a firearm as described above, upon logging into the law enforcement module 340 and searching for the found firearm based on its serial number, the tracking module 310 may only return an indication whether or not a firearm information record exists for the found firearm. To obtain additional information, in an embodiment the law enforcement agency may require a subpoena and/or other court order.

Further, the transfer of information between and among the various nodes and modules of the integrated firearm information system 300 of an embodiment may be encrypted by any known encryption technique or protocol to substantially ensure that the privacy rules and policies are not bypassed or circumvented by inadvertent or accidental access to the firearm information, and that the firearm information data itself may not be vulnerable to more nefarious intrusions and hacks. Further, in an embodiment, at least the node including the tracking module 310 may be located in a substantially secure physical location to substantially further prevent local unauthorized or malicious data access in addition to remote access.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware. In yet another example, an embodiment may be implemented by any combination of programmed general-purpose computer components and custom hardware components. The embodiments are not limited in this context.

Various embodiments may be implemented using one or more hardware elements. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Various embodiments may be implemented using one or more software elements. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations. The software may be written or coded using a programming language. Examples of programming languages may include C, C++, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software may also be stored on the media as compressed and/or encrypted data. Examples of software may include any software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

We claim:

1. A firearm information system comprising:
a tracking module to generate, store, and organize one or more firearm information records corresponding to one or more firearms, the one or more firearm information records including firearm data; and
a manufacturer module coupled to the tracking module to provide firearm data from a firearm manufacturer to the one or more firearm information records corresponding to one or more firearms manufactured by the firearm manufacturer.

2. The firearm information system of claim 1, the firearm data from the firearm manufacturer further comprising a firearm description, a firearm type, a unique firearm identifier, a serial number, one or more ballistic data, or a combination thereof.

3. The firearm information system of claim 2, the firearm data from the firearm manufacturer to uniquely identify each of the one or more firearms manufactured by the firearm manufacturer.

4. The firearm information system of claim 2 further comprising:
a seller module coupled to the tracking module to provide ownership data from a firearm seller to the one or more firearm information records corresponding to one or more firearms sold by the firearm seller.

5. The firearm information system of claim 2 further comprising:
a law enforcement module coupled to the tracking module to search ownership data, firearm data, or a combination thereof of the one or more firearm information records corresponding to one or more firearms found, collected, reported stolen, or a combination thereof by a law enforcement agency.

6. The firearm information system of claim 2 further comprising:
a government agency module coupled to the tracking module to monitor ownership data, firearm data, or a combination thereof of the one or more firearm information records for regulatory compliance, administrative compliance, legal compliance, or a combination thereof.

7. The firearm information system of claim 2 further comprising:
an individual module coupled to the tracking module to provide firearm data from an individual firearm owner to the one or more firearm information records corresponding to one or more firearms owned and/or possessed by the individual firearm owner.

8. A firearm information system comprising:
a tracking module to generate, store, and organize one or more firearm information records corresponding to one or more firearms, the one or more firearm information records including firearm data; and
an individual module coupled to the tracking module to provide firearm data from an individual firearm owner to the one or more firearm information records corresponding to one or more firearms owned and/or possessed by the individual firearm owner.
